(19) United States
(12) Patent Application Publication
(10) Pub. No.: US 2006/0119565 A1
(43) Pub. Date: Jun. 8, 2006

(54) Lighting device, flat-panel display device and lighting method

(76) Inventor: Kazuki Matsumoto, Kanazawa-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/282,650

(22) Filed: Nov. 21, 2005

(30) Foreign Application Priority Data
Dec. 3, 2004 (JP) 2004-351746

(51) Int. Cl. G09G 3/36

(52) U.S. Cl. 345/102

(57) ABSTRACT

A lighting device is provided with a number of light sources and a driving circuit. Each of the light sources includes a plurality of light emitting elements which emit respective light having different wavelengths, combines the respective light into white light, and emit the white light onto a flat display panel. The driving circuit periodically drives the light sources in accordance with driving pattern signals each corresponding to the ratio between times for which the light emitting elements emit the respective light, and shifts the phases of the driving pattern signals relative to each other for the light sources.

### CROSS-REFERENCE TO RELATED APPLICATIONS

This application is based upon and claims the benefit of priority from prior Japanese Patent Application No. 2004-351746, filed Dec. 3, 2004, the entire contents of which are incorporated herein by reference.

### BACKGROUND OF THE INVENTION

1. Field of the Invention

The present invention relates to a lighting device provided with a number of light-emitting elements, a flat-panel display device incorporating the lighting device, and a lighting method to be applied by using the lighting device.

2. Description of the Related Art

In recent years, a flat-panel display device such as a liquid crystal display device has been required to achieve display of high brightness, which comprises a liquid crystal display panel and a lighting device. The liquid crystal display panel comprises an array substrate, an opposing substrate which is arranged opposite to the array substrate with a gap therebetween, and a liquid crystal layer held therebetween. The array substrate and the opposing substrate are bonded to each other by seal members provided on their peripheral edge portions.

The lighting device is provided on a reverse side of the liquid crystal display panel which is located opposite to a display surface thereof, i.e., it is located outward of the array substrate. The lighting device comprises a light source and a driving circuit for driving the light source. As the light source, a cold-cathode tube is used. However, in recent years, a lighting device using a number of light-emitting diodes (which will be hereinafter referred to as LEDs) has been developed.

If LEDs are used in the light source, they are, for example, red LEDs, green LEDs and blue LEDs, and the lighting device emits white light by driving those LEDs. In this case, the LEDs are driven in synchronism with clock signals generated by the driving circuit.

When the above LEDs are driven in order that the lighting device emit white light, they emit respective light for different times in a time period corresponding to one frame, in which all the pixels of the liquid crystal panel 2 are scanned once. However, in this case, the lighting device instantaneously emits red, green or blue light, or a mixture of red, green and blue or black light. That is, a so-called white-color breaking phenomenon occurs. Accordingly, the lighting device cannot emit white light continuously without emission of light of another color, as a result of which a white-color breaking phenomenon occurs at a display surface of a liquid crystal display panel, thus lowering the quality of the display.

The present invention has been developed in view of the above circumstances, and its object is to provide a lighting device which can continuously emit white light without emitting light of another color, a flat-panel display device provided with the lighting device, and a lighting method for causing white light to be emitted continuously without emission of light of another color.

### BRIEF SUMMARY OF THE INVENTION

In order to achieve the above object, a light device according to one aspect of the present invention comprise: a plurality of light sources each of which comprises a plurality of light emitting elements configured to emit respective light having different wavelengths, and combines the respective light into white light, and then emits the white light onto a flat display panel; and a driving circuit which periodically drives the plurality of light sources in accordance with driving pattern signals each corresponding to a ratio between times for which the plurality of light emitting elements of said each light source emit the respective light, and which shifts phases of the driving pattern signals relative to each other for the plurality of light sources.

A plat-panel display device according to another aspect of the present invention comprises: a flat display panel; and a lighting device which comprises (i) a plurality of light sources each of which includes a plurality of light emitting elements configured to emit respective light having different wavelengths, and which combines the respective light into white light, and emits the white light onto the flat display panel, and (ii) a driving circuit which periodically drives the plurality of light sources in accordance with driving pattern signals each corresponding to a ratio between times for which the plurality of light emitting elements of said each light source emit the respective light, and which shifts phases of the driving pattern signals relative to,each other for the plurality of light sources.

A lighting method according to a further aspect of the present invention comprises: periodically drives a plurality of light sources, each of which comprises a plurality of light emitting elements, in accordance with driving pattern signals each corresponding to a ratio between times for which the plurality of light emitting elements of said each light source emit the respective light, the plurality of light sources being configured to combine the respective light into white light, and emit the white light onto a flat display panel; and shifting phases of the driving pattern signals relative to each other for the plurality of light sources.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a vertical sectional view of a liquid crystal display device according to an embodiment.

FIG. 2 is a schematic plan view of a backlighting unit shown in FIG. 1.

FIG. 3 is a timing chart for use in explaining an operation of the backlighting unit.

FIG. 4 is a schematic plan view of a modification of the backlighting unit.

### DETAILED DESCRIPTION OF THE INVENTION

An embodiment of the present invention will be explained in detailed with reference to the accompanying drawings. In the embodiment, the present invention is applied to a liquid crystal display device which is a flat-panel display device.

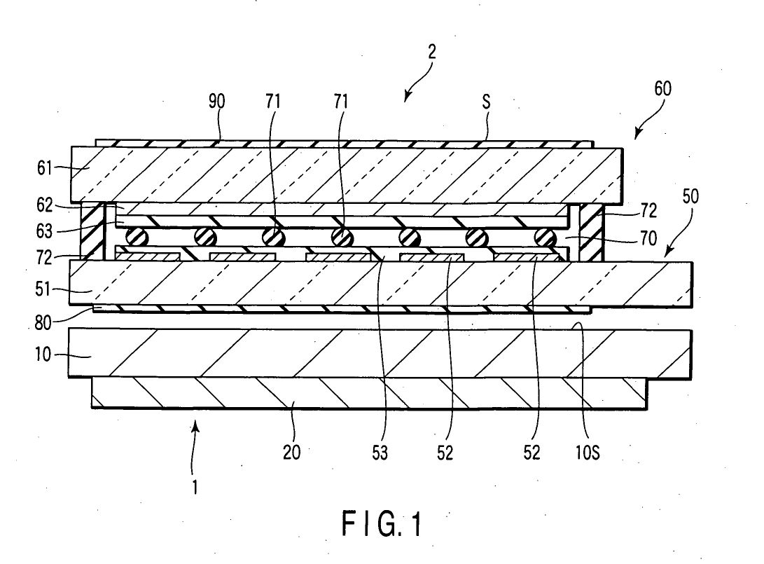

As shown in FIG. 1, the liquid crystal display device according to the embodiment comprises a backlighting unit 1 as a lighting device and a liquid crystal display panel 2 as a flat display panel.

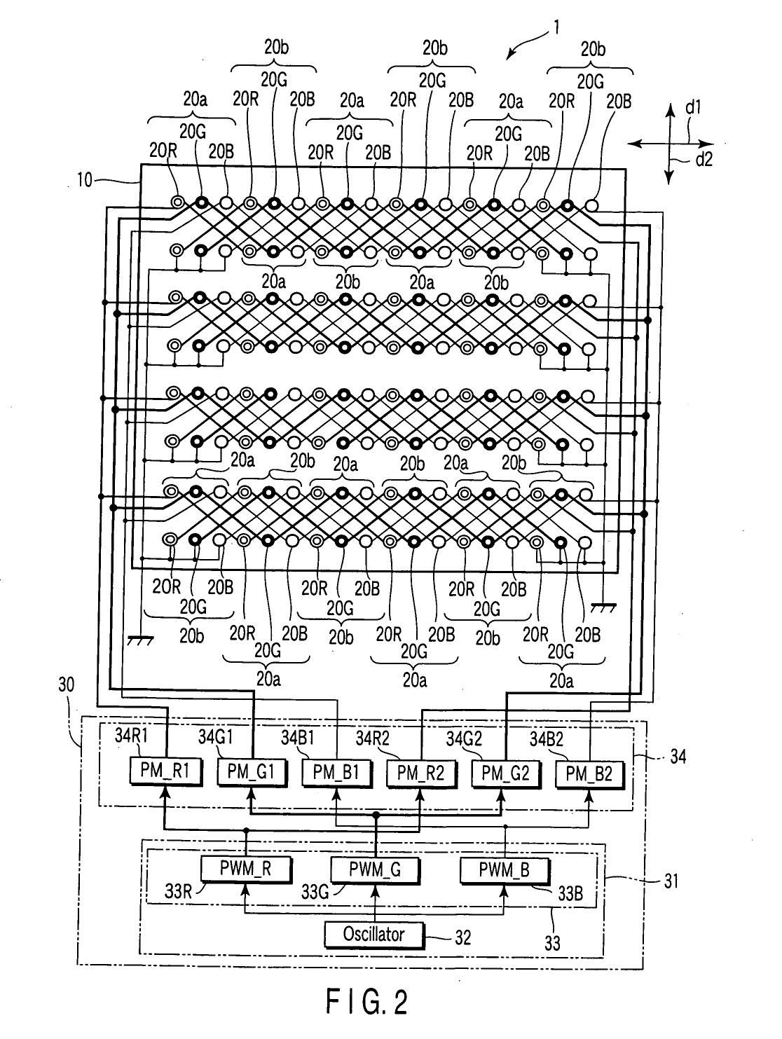

As shown in FIGS. 1 and 2, the backlighting unit 1 comprises a light source 20, a driving circuit 30 and a light guiding plate 10 serving as a transparent member, which includes a light emission surface 10S. It should be noted that in the backlighting unit 1, an optical system, e.g., a prism sheet and a diffusion film, not shown, may be formed on the light guiding plate 10.

The light source 20 lights the liquid crystal display panel 2, and is located on an outer surface of the light guiding plate 10 which is opposite to the light emission surface 10S. In the embodiment, the light source 20 comprises a first light source and a second light source (respectively corresponding to a first light source 20a and a second light source 20b which will be described later). Each of the light sources comprises red LEDs 20R, green LEDs 20G and blue LEDs 20B as a plurality of light-emitting elements which are designed to emit respective light having different wavelengths.

The driving circuit 30 periodically drives the light sources in accordance with clock signals serving as driving pattern signals, which represent the ratio between times for which the LEDs 20R, 20G and 20B emit respective light, which is combined into white light. The driving circuit 30 is designed to shift the phases of the clock signals for the light sources relative to each other.

The driving circuit 30 will be explained in detail.

The driving circuit 30 comprises a signal generating section 31 and a phase adjusting section 34. The signal generating section 31 comprises an oscillator 32 for generating a driving signal and a pulse-width modulator 33. The pulse-width modulator 33 modulates the pulse widths of clock signals generated by the oscillator 32, to thereby provide clock signals having different pulse widths for LEDs 20R, 20G and 20B, respectively.

In the embodiment, the pulse-width modulator 33 comprises a first pulse-width modulator (PWM_R) 33R for the red LEDs 20R, a second pulse-width modulator (PWM G) 33G for the green LEDs and a third pulse-width modulator (PWM_B) 33B for the blue LEDs. Thus, the pulse widths of clock signals for each of pairs or groups of LEDs which emit light having respective colors can be modulated.

The phase adjusting section 34 comprises a first phase adjusting section (PM_R1) 34R1, a second phase adjusting section (PM_G1) 34G1, a third phase adjusting section (PM_B1) 34B1, a fourth phase adjusting section (PM_R2) 34R2, a fifth phase adjusting section (PM_G2) 34G2, and a sixth phase adjusting section (PM_B2) 34B2. The first phase adjusting section (PM_R1) 34R1 and the fourth phase adjusting section (PM_R2) 34R2 are provided for the red LEDs 20R. The second phase adjusting section (PM_G1) 34G1 and the fifth phase adjusting section (PM_G2) 34G2 are provided for the green LEDs 20G. The third phase adjusting section (PM B1) 34B1 and the sixth phase adjusting section (PM_B2) 34B2 are provided for the blue LEDs 20B.

A clock signal the pulse width of which is modulated by the first pulse-width modulator 33R is input to the first phase adjusting section 34R1 and the fourth phase adjusting section 34R2. The first phase adjusting section 34R1 and the fourth phase adjusting section 34R2 output clock signals such that the phase of one of the clock signals is shifted from that of the other or others. The LEDs 20R are respectively driven by the clock signals output from the first phase adjusting section 34R1 and the fourth phase adjusting section 34R2.

A clock signal the pulse width of which is modulated by the second pulse-width modulator 33G is input to the second phase adjusting section 34G1 and the fifth phase adjusting section 34G2. The second phase adjusting section 34G1 and the fifth phase adjusting section 34G2 output clock signals such that the phase of one of the clock signals is shifted from that of the other or others. The LEDs 20G are respectively driven by the clock signals output from the second phase adjusting section 34G1 and the fifth phase adjusting section 34G2.

A clock signal the pulse width of which is modulated by the third pulse-width modulator 33B is input to the third phase adjusting section 34B1 and the sixth phase adjusting section 34B2. The third phase adjusting section 34B1 and the sixth phase adjusting section 34B2 output clock signals such that the phase of one of the clock signals is shifted from that of the other or others. The LEDs 20B are respectively driven by the clock signals output from the third phase adjusting section 34B1 and the sixth phase adjusting section 34B2.

By virtue of the above feature, the phase adjusting section 34 can output clock signals for each of the pairs or groups of LEDs which emits light having respective colors, such that the phases of the clock signals are shifted relative to each other.

Of all the above LEDs 20R, 20G and 20B, LEDs 20R, 20G and 20B which receive clock signals from the first phase adjusting section 34R1, the second phase adjusting section 34G1 and the third phase adjusting section 34B1 serve as a first light source 20a, and LEDs 20R, 20G and 20B which receive clock signals from the fourth phase adjusting section 34R2, the fifth phase adjusting section 34G2 and the sixth phase adjusting section 34B2 serve as a second light source 20b.

The first light source 20a and the second light source 20b will be explained in detail.

The first light source 20a and the second light source 20b are driven by clock signals which are generated in such a manner as to set a relationship between the times during which the LEDs emit respective light, so that white light can be emitted continuously. It should be noted that as described later, the phases of the clock signals for the first light source 20a and those of the clock signals for the second light source 20b is shifted relative to each other by the phase adjusting section 34.

The LEDs 20R, 20G and 20B of the first light source 20a and those of the second light source 20b are substantially regularly arranged in a pattern shown in FIG. 2 with respect to a flat surface of the liquid crystal panel 2 which is parallel to the outer surface of the light guiding plate 10, i.e., an outer surface of a first polarizer 80. Also, the LEDs of the first light source 20a and those of the second light source 20b are alternately arranged in first and second directions d1 and d2 perpendicular to each other as shown in FIG. 2. Thereby, of light emitted from the light emission surface 10S, at least light transmitted through a display surface S is emitted as good white light, since the unevenness of its color and brightness is restricted.

As shown in FIG. 1, the liquid crystal display panel 2 comprises an array substrate 50 located opposite to the light emission surface 10S, an opposing substrate 60, a liquid crystal layer 70, the first polarizer 80 and a second polarizer 90.

The array substrate 50 comprises a glass substrate 51, a plurality of pixel electrodes 52 formed on the glass substrate 51, and an alignment film 53 formed on the pixel electrode 52 and the glass substrate 51. The pixel electrodes 52 form respective pixels. Furthermore, the array substrate 50 includes various wiring (not shown) and thin film transistors (not shown) serving as switching elements formed on the glass substrate 51, etc.

The opposing substrate 60 comprises a glass substrate 61, a common electrode 62 formed on the glass substrate 61 and an alignment film 63 formed on the common electrode 63. The pixel electrodes 52 and the common electrode 62 are formed of transparent conductive material such as ITO (indium-tin-oxide). The alignment films 53 and 63 are subjected to rubbing as an alignment film treatment process.

The array substrate 50 and the opposing substrate 60 are arranged opposite to each other with a predetermined gap by a plurality of spacers 71. Also, the array substrate 50 and the opposing substrate 60 are adhered to each other by a seal member 72 provided on peripheral edge portion of the array substrate 50 or the opposing substrate 60. The liquid crystal layer 70 is held between the array substrate 50, the opposing substrate 60 and the seal members 72. The first polarizer 80 is located on an outer surface of the array substrate 50, and the second polarizer 90 is located on an outer surface of the opposing substrate 60. An outer surface of the second polarizer 90 serves as the display surface S.

Next, how the backlighting unit 1 is driven will be explained in detail.

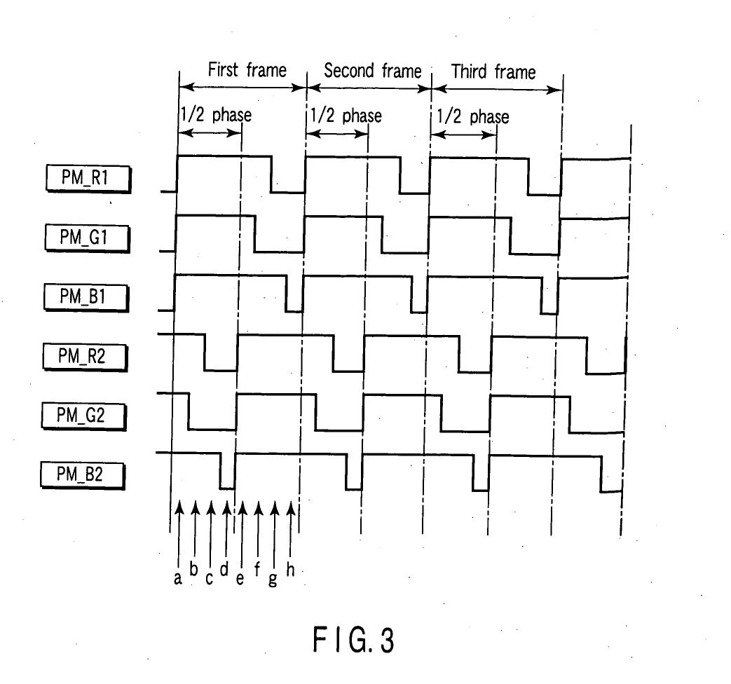

The waveforms shown in FIG. 3 are those of clock signals which represent times during which the LEDs 20R, 20G and 20B emit light, respectively, and which are output from the first phase adjusting section 34R1 to sixth phase adjusting section 34B2. How the levels of the clock signals change in a time period corresponding to a first frame will be explained. The time period corresponding to one frame such as the first frame is a time period required to scan all the pixels of the liquid crystal display panel 2 once. Normally, it is approximately 16 msec.

At timing a, the clock signals output from the first phase adjusting section 34R1 to third phase adjusting section 34B2 for the first light source 20a all change to high level, and are kept at high level at timings b, c and d.

At timing e, the phases of all the clock signals shift by half of the first frame from the rising edges of the clock signal, the clock signals output from the fourth phase adjusting section 34R2 to sixth phase adjusting section 34B2 for the second light source 20b all change to high level. In the embodiment, since two light sources, i.e., the first light source 20a and the second light source 20b, are provided, the phases of the clock signals from the fourth phase adjusting section 34R2 to sixth phase adjusting section 34B2 are shifted from those of the clock signals from the first phase adjusting section 34R1-to third phase adjusting section 34B2 by half of the first frame.

Thereafter, at timing f, the clock signal from the second phase adjusting section 34G1 changes to low level, and the color of the light emitted from the first light source 20a changes to a mixture of red and blue. However, at this time, since the second light source 20a emits white light, occurrence of the white-color braking phenomenon is prevented, and the color of the light emitted from the backlighting unit 1 is kept white.

At timing g, the clock signal of the first phase adjusting section 34R1 changes to low level, as a result of which the first light source 20a emits blue light. However, since the second light source 20b emits white light, occurrence of the white-color breaking phenomenon is prevented, and the color of the light from the backlighting unit 1 is kept white.

At timing h, the clock signal of the third phase adjusting section 34B1 changes to low level, and the first light source 20a thus becomes in the OFF state, i.e., it does not emit light. However, since the second light source 20b emits white light, the color of the light from the backlighting unit 1 is kept white.

Then, in the second and third frames, the first light source 20a and the second light source 20b are driven in the same manner as in the first frame. As is clear from the above, at any of the timings a to h, the backlighting unit 1 can emit white light.

In such a manner, in the backlighting unit 1, the liquid crystal display device and the lighting method of the backlighting unit, the driving circuit 30 periodically drives each of the first light source 20a and the second light source 20b in a pattern corresponding to the ratio between the light emitting times of the LEDs 20R, 20G and 20B in the first and second light sources 20a and 20b, which combine respective light into white light. The phase adjusting section 34, as described above, has a function of causing the phases of the clock signals for the first and second light sources 20a and 20b to be shifted relative to each other. Thus, by virtue of the above structural features, a combination of the first and second light sources 20a and 20b can emit white light continuously without emission of light of another color. Thus, at the light emission surface 10S, occurrence of the white-color breaking phenomenon is prevented.

The LEDs 20R, 20G and 20B of the first and second light sources 20a and 20b are flatly substantially regularly arranged with respect to the outer surface of the light guiding plate 10 and the flat surface of the liquid crystal display panel 2. Thus, the backlighting unit 1 can restrict the unevenness of color and brightness of light emitted thereby, that is, it can emit good white light.

The backlighting unit 1, as described above, includes the above two light sources. Thus, of the phases of pairs or groups of LEDs which emit respective light, the phases of each pair or group of LEDs, i.e., those of LEDs which emit light having the same color, are shifted relative to each other by half of one frame by the phase adjusting section 34. Thereby, a white-color breaking phenomenon can be most effectively prevented. Furthermore, if the backlighting unit 1 includes six light sources, the phase adjusting section 34 is set to adjust the phases of each pair or group of LEDs which emit light having the same color such that they are shifted relative to each other by sixth of one frame. Accordingly, if the backlighting unit 1 includes an N number of light sources, the phase adjusting section 34 adjusts the phases of each pair or group of LEDs which emit light having the same color such that they are shifted relative to each other by 1/N of one frame. Thus, occurrence of a white-color breaking phenomenon can be most effectively prevented.

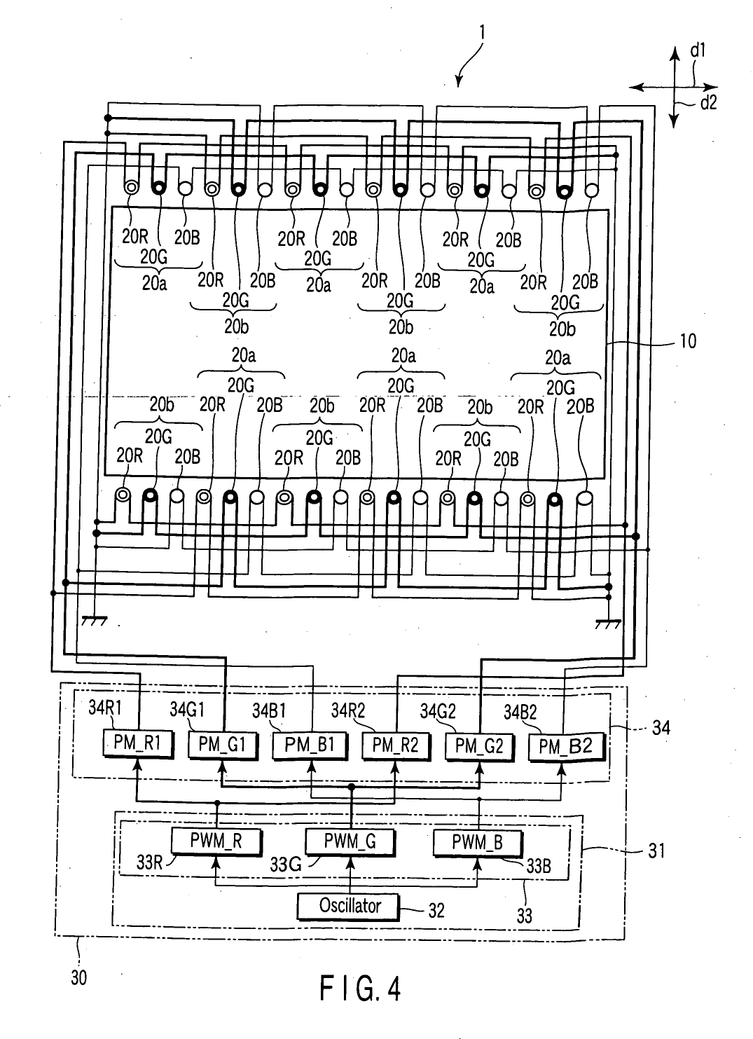

The present invention is not limited to the above embodiment, and various modifications may be made within the scope of the invention. For example, as shown in FIG. 4, the LEDs 20R, 20G and 20B of the first light source 20a and those of the second light source 20b may be provided close to side edges of the light guiding plate 10 and opposite to each other with respect to the light guiding plate 10 in the second direction d2, and may also be arranged in the first direction d1. Furthermore, in the case where a plurality of light sources are provided, their LEDs may be provided close to only one side edge of the light guiding plate 10, or they may be close to three side edges or four side edges of the light guiding plate 10.

Also, as described above, each of the first and second light sources 20a and 20b comprises LEDs 20R, 20G and 20B, and light emitted from the LEDs 20R, 20G and 20B are combined into white light. However, each light source may comprise white LEDs only, which all emit white light. In this case also, the backlighting unit 1 can necessarily emit white light.

In addition, as mentioned above, the backlighting unit 1 includes the above two light sources. However, it may include three or more light sources.

The above explanation of the embodiment is given as a matter of convenience for explanation by referring to the case where each of the cycles of each clock signal (PWM signal) corresponds to one frame. However, in an actual clock signal, several cycles or several tens of cycles correspond to one frame. Also, the actual clock signal synchronizes with frames.

The present invention is not limited to the liquid crystal display device, that is, it can be applied to a flat-panel display device provided with the backlighting unit 1.

What is claimed is:

1. A lighting device comprising:
a plurality of light sources each of which comprises a plurality of light emitting elements configured to emit respective light having different wavelengths, and combines the respective light into white light, and then emits the white light onto a flat display panel; and
a driving circuit which periodically drives the plurality of light sources in accordance with driving pattern signals each corresponding to a ratio between times for which the plurality of light emitting elements of said each light source emit the respective light, and which shifts phases of the driving pattern signals relative to each other for the plurality of light sources.

2. The lighting device according to claim 1, wherein the driving circuit comprises:
a signal generating section which generates the driving pattern signals having different pulse widths for the plurality of light emitting elements of said each light source, respectively; and
a phase adjusting section which shifts the phases of the driving pattern signals for each of pairs or groups of light emitting elements included in the plurality of light sources from each other, said each pair or group of light emitting elements being configured to emit light having the same wavelength.

3. The lighting device according to claim 2, wherein the signal generating section comprises:
an oscillator which generates driving signals; and
a pulse-width modulator which modulates pulse widths of the driving pattern signals by using driving signals generated by the oscillator, to thereby provide driving pattern signals having different pulse widths for the plurality of light emitting elements of said each light source, respectively.

4. The lighting device according to claim 1, wherein the number of the plurality of light sources is N, and the phases of the driving pattern signals for each of pairs or groups of light emitting elements included in the plurality of light sources are shifted relative to each other by 1/N of one frame, said each pair or group of light emitting elements being configured to emit light having the same wavelength.

5. The lighting device according to claim 1, wherein the light emitting elements of the plurality of light sources are substantially regularly arranged with respect to a flat surface of the flat display panel.

6. The lighting device according to claim 4, wherein the light emitting elements of the plurality of light sources are alternately arranged in first and second directions perpendicular to each other.

7. The lighting device according to claim 1, which further comprises a light guiding plate, and wherein the light emitting elements of the plurality of light sources are alternately arranged along a side edge of the light guiding plate.

8. The lighting device according to claim 1, wherein the plurality of light emitting elements emit red light, green light and blue light, respectively.

9. A plat-panel display device comprising:
a flat display panel;
a lighting device which comprises (i) a plurality of light sources each of which includes a plurality of light emitting elements configured to emit respective light having different wavelengths, and which combines the respective light into white light, and emits the white light onto the flat display panel, and (ii) a driving circuit which periodically drives the plurality of light sources in accordance with driving pattern signals each corresponding to a ratio between times for which the plurality of light emitting elements of said each light source emit the respective light, and which shifts phases of the driving pattern signals relative to each other for the plurality of light sources.

10. A lighting method comprising:
periodically drives a plurality of light sources, each of which comprises a plurality of light emitting elements, in accordance with driving pattern signals each corresponding to a ratio between times for which the plurality of light emitting elements of said each light source emit the respective light, the plurality of light sources being configured to combine the respective light into white light, and emits the white light onto a flat display panel; and
shifting phases of the driving pattern signals relative to each other for the plurality of light sources.

11. The light method according to claim 10, wherein of the driving pattern signals, pairs or groups of driving pattern signals are respectively output for pairs or groups of light emitting elements included in the plurality of light sources, which emit respective light having different wavelengths, and when the number of the light sources is N, phases of the driving pattern signals for each of the pairs or groups of light emitting elements are shifted relative to each other by 1/N of one frame, said each pair or group of light emitting elements being configured to emit light having the same wavelength.
